(19) United States
(12) Patent Application Publication
(10) Pub. No.: US 2010/0057668 A1
(43) Pub. Date: Mar. 4, 2010

(54) MAPPING HUMAN-MEANINGFUL PARAMETERS TO NETWORK-MEANINGFUL PARAMETERS FOR MEDIA TRANSFORMATION

(75) Inventors: FRANKLYN S. NELSON, Alameda, CA (US); KENDRA HARRINGTON, Irvine, CA (US); ALLEN JOSEPH HUOTARI, Garden Grove, CA (US)

Correspondence Address: Patent Capital Group - Cisco, 6119 McCommas, Dallas, TX, 75214, US

(73) Assignee: CISCO TECHNOLOGY, INC.

(21) Appl. No.: 12/204,143

(22) Filed: Sep. 4, 2008

(51) Int. Cl. G06N 5/02; G06F 7/00; G06F 17/30

(52) U.S. Cl. 706/60; 707/102; 707/E17.009

(57) ABSTRACT

A method of permitting a user to define preferred and acceptable audio/video experiences in a home network in terms that are meaningful for a human and that are translated to useful content transformation parameters.

### I. FIELD OF THE INVENTION

The present application relates generally to mapping human-meaningful parameters to network-meaningful parameters for media transformation.

### II. BACKGROUND OF THE INVENTION

As networking and digital media technologies advance, network-enabled consumer electronic devices have been introduced that can store, manage, and/or playback different types of digital media content. For example, all of a user's digital music, video and photos may be stored on a network storage device, and a digital media player used to render all the content on the HDTV in a user's living room.

### BRIEF DESCRIPTION OF THE DRAWINGS

The details of non-limiting embodiments, both as to its structure and operation, can best be understood in reference to the accompanying drawings, in which like reference numerals refer to like parts, and in which:

FIG. 1 is a block diagram of an example system;

FIG. 2 is a flow chart of example overall logic; and

FIGS. 3-5 are screen shots of example user interfaces in accordance with present principles.

### DESCRIPTION OF EXAMPLE EMBODIMENTS

### Overview

As understood herein, it is possible that the data transmission conditions of a home network may not be able to support content requested in a particular format for a multimedia stream but may be able to support that same content if provided in an alternate format. As an example, a network may not be able to support a 20 Mbps MPEG2 High Definition Video stream but could support a 10 Mbps MPEG4 part10 High Definition Video stream or a 6 Mbps MPEG2 Standard Definition Stream.

Alternately, content may be available in one format but not another. As an example, an audio stream (a song) may only be available in MP3 and not WMA or vice versa.

As further understood herein, in any of the above instances, it is likely that end users will accept an alternate format provided that they are not required to make a significant number of choices (especially complex ones) in order to play the content.

Accordingly, easy to understand, human meaningful parameters are mapped to network relevant parameters in order to assign transformation of media. In example embodiments, this can involve, upon demand, automatically locating acceptably formatted alternate content (transformed upon or prior to demand) and transforming content in real time to an acceptable alternate.

With this in mind, a device is configured to establish communication between a wide area network and a home network. The device has a processor and a tangible computer-readable medium accessible to the processor and bearing a data structure correlating terms that are meaningful to a human to respective network parameters to implement user-defined content transformation policy in the home network.

In another example, an apparatus has a processor and a computer-readable medium accessible to the processor and bearing mapping between content transformation policy and human-meaningful terms in a home network. The content transformation policy is useful by a computer to effect media transformation in the home network. The human-meaningful terms are useful for presenting a user interface to a person.

In non-limiting examples the user interface can be operable to establish preferred policy in terms of the human-meaningful terms. The human-meaningful terms may include display definition types such as “HD” and “SD” and/or audio file source types such as “CD”, “stereo”, “mono”, etc. A user may change from a default policy using the human-meaningful terms. The human-meaningful terms typically may be mapped to content transformation parameters understandable by a computer to transform a first media content type to a second media content type.

In another example, a method includes establishing relationships between content transformation parameters and abstractions of the content transformation parameters, and displaying the abstractions. The method can also include permitting a user to establish user-preferred media profiles in a home network using the abstractions. The user-preferred media profiles can be implemented using the content transformation parameters.

### Description of Example Embodiments

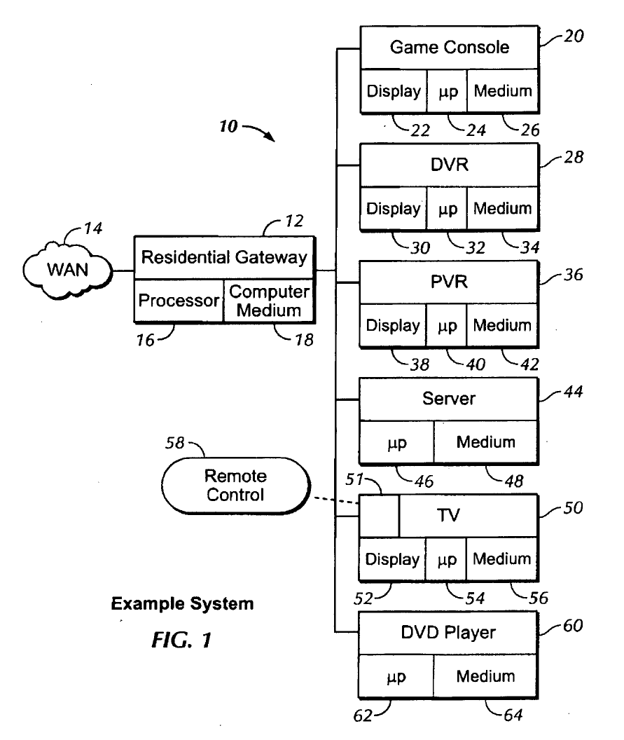

Referring initially to FIG. 1, a home network is shown, generally designated 10, which includes a residential gateway (RG) 12 that is configured to establish communication between a wide area network (WAN) 14 and plural consumer electronics (CE) devices communicating over the home network using, in one example implementation, Universal Plug-n-Play (UPnP™). The RG 12 includes a RG processor 16 and a RG tangible computer-readable medium 18 accessible to the RG processor 16.

By way of non-limiting example, the CE devices of the home network 10 may include game console 20 with video display 22, processor 24, and computer-readable medium 26. The home network 10 may also include a digital video recorder (DVR) 28 that in some embodiments may include a video display 30, processor 32, and computer-readable medium 34. The home network 10 may also include a personal video recorder (PVR) 36 that in some embodiments may include a video display 38, processor 40, and computer-readable medium 42. Further, the home network 10 may include a server computer 44 that includes a processor 46 and computer-readable medium 48. A TV 50 may also be included in the network 10, and the TV 50 typically includes, among TV components such as a tuner 51, a TV display 52, TV processor 54, and computer readable medium 56. The TV 50 may be controlled using a remote control 58. A DVD player 60 may also be on the network and can include a processor 62 and computer readable medium 64.

The logic described herein may be stored in the form of computer-readable code on any one or more of the above-described computer readable media for execution by any one or more of the above-described processors. In one embodiment the logic is implemented by the RG 12. In any case, the computer-readable media may be, without limitation, disk drives, solid state memory, etc.

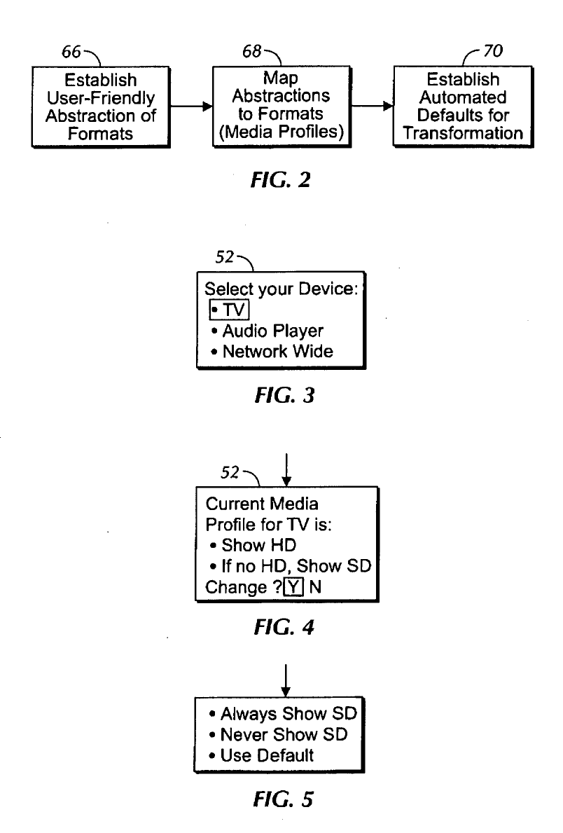

The overall logic may be seen in reference to FIG. 2. Commencing at block 66, human-meaningful terms are established for subsequent mapping to content transformation parameters. The human-meaningful terms are examples of abstractions of the respective content transformation parameters that are more easily understood and thus more useful to a non-technical user than are the content transformation parameters.

Examples of human-meaningful terms for audio include “CD quality”, “MP3 quality”, “FM quality”, “AM quality”, etc. Alternative audio human-meaningful terms may be “multichannel stereo”, “two channel stereo (high fidelity)”, “two channel stereo (medium fidelity)”, “mono (low fidelity)”.

Examples of human-meaningful terms for video include “High Definition”, “Standard Definition”, “DVD quality”, “VHS quality”, “TV quality”, etc. Alternative video human-meaningful terms include “high resolution”, “standard resolution”, “medium resolution”, “low resolution”. It is to be understood that the list of human-meaningful terms can be static or dynamic and can depend upon network and/or device capabilities.

Moving to block 68, the human-meaningful terms are mapped to content transformation parameters. In some embodiments, an initial default mapping is provided as described below. The user may be given the option to change the mapping.

As understood herein, content transformation, which can be used to reduce the quality of an audio/video stream, primarily via reducing the bit rate via transrating, includes not only transrating (the conversion of one digital bit rate to another) but also transcoding (the conversion of one digital encoding format to another), with transcoding from one format to another typically requiring transrating. Among non-limiting example formats (examples of content transformation parameters) are the audio formats defined by the digital living network alliance (DLNA) and known as arc-consistency algorithm three (AC-3), audio modem riser (AMR), adaptive transform acoustic coding (ATRAC), linear pulse code modulation (LPCM), MP3, moving picture experts group-4 (MPEG4), and Windows media audio (WMA). Additional audio formats include free lossless audio code (FLAC), Ogg Vorbis, waveform audio (WAV).

DLNA also defines the non-limiting example video formats of MPEG1, MPEG2, MPEG4 part2 (including H.263), MPEG4 part10 (advanced video coding (AVC), H.264), digital video express (DivX), and WMV9. Furthermore, each of these formats may define a number of profiles. Audio profiles may be distinguished by sampling rate, bit rate, and number of channels, while video profiles can be distinguished by frame rate, bit rate, and resolution.

With this in mind, non-limiting example mappings may now be understood. As an example of mapping in the audio domain, LPCM, the coding format used for CDs (16 bit stereo, 44.1 kHz sampling rate) can be mapped to the human-meaningful term “CD”. “FM” may be mapped to MP3. In this example, in the event that, in accordance with disclosure below, the user indicates that audio files preferably are delivered with “CD quality” but if network bandwidth is insufficient, then “FM quality” is acceptable, a transformation policy may be implemented to map from CD quality to FM quality by defining this as LPCM to MP3.

Alternate transformation parameters may be assigned to the human-meaningful abstractions of “CD quality” and “FM quality”. As an example, content of the WMA-full type may be mapped by default to “CD quality” whereas WMA base can be mapped by default to “FM quality”. In either of these cases, allowing a user to assign as “minimum quality=FM (two channel stereo (medium fidelity)” can be interpreted by the network as “FM quality is acceptable but higher quality is preferred” with the result that MP3 (or WMA base) formatted files could be played if LPCM (or WMA full) formatted files are not found, not available, or the network cannot support the bit rate required for “CD quality audio”.

Example video mappings include mapping the human-meaningful abstraction “high definition” to MPEG2 and/or MPEG4 part10 and/or WMA, all of which support HD as well as standard definition (SD) and medium to low resolutions. On the other hand, MPEG2, National Television System Committee (NTSC), and phase alternating line (PAL) (used for North American and European DVD formats) may be mapped to the human-friendly term “Standard Definition (SD)”. Alternatively, SD may be represented by the term “DVD quality” or vice versa when it comes to user preferences.

Moving to block 70, a default transformation policy that the user subsequently can modify is established. The policy may depend on device capabilities. For example, if the network (using, e.g., Universal Plug-n-Play (UPnP) discovery principles) discovers that the TV 50 is a HDTV, the default policy may be “display MPEG4 part 10 streams on the TV 50 unless network congestion prohibits it, in which case transform the MPEG4 part 10 to PAL and display the PAL”. Similar default policies may be applied to audio players, e.g., “send LPCM streams to player #1 unless network congestion prohibits it, in which case transform the LPCM streams to MP3”.

FIGS. 3-5 illustrate an example of a user interface (UI) that may be presented on, e.g., the TV display 52 and used to change the default policies, using the human-meaningful terms in the UI which are mapped to the network-understandable transformation parameters discussed above. In FIG. 3, assume the user has entered “transformation policy” from, e.g., an initial setup menu. The first level menu may permit the user to establish policy on a device-by device basis or on a network-wide basis as shown.

Assuming the user has selected “TV” in FIG. 3, the user interface of FIG. 4 may appear, in which the current media profile (transformation policy) in human-meaningful terms is presented. In the example, the current policy is to show HD on the TV unless HD is not available (due to no HD streams or due to the inability of the network to deliver HD), in which case SD is to be shown. This means that if HD streams are available but network congestion prevents transmission of HD, the HD streams are automatically transcoded, either real time or prior to demand, to SD.

Assume the user has selected “yes I want to change the media profile” in FIG. 4. The UI of FIG. 5 may then appear listing alternate policies, e.g., “always show SD” (which a user may elect knowing, for example, that the network is typically limited in bandwidth), “never show HD” (which the user may elect for some but not all TVs in the network, for example), and “use default”. By selecting the desired media profile, the user instructs the network how to handle subsequent transformation policy for the particular device being selected.

As further examples, a modest sound system in a bedroom or office may be selected as “minimum quality=FM” (2 channel stereo (medium fidelity)), whereas a premium sound system may be selected as “minimum quality=CD 2 channel stereo (high fidelity)”. This latter media profile for the device (transformation policy) may be interpreted by the network as “do not play unless CD quality can be achieved” whereas the former case may be interpreted by the network as “FM quality is acceptable but higher quality is preferred”. Transformation is then executed as necessary to conform to the policy. Thus, from one aspect the process of choosing some transformed content represents a form of conflict resolution for an instance where an original request for traffic cannot be honored but an alternate request may be honored and is acceptable to the user.

Present principles are not limited to any particular mode of content transformation. Existing transformation applications from one format to another may be used.

While the particular MAPPING HUMAN-MEANINGFUL PARAMETERS TO NETWORK-MEANINGFUL PARAMETERS FOR MEDIA TRANSFORMATION is herein shown and described in detail, it is to be understood that the subject matter which is encompassed by the present invention is limited only by the claims.

What is claimed is:

1. Method comprising:
establishing relationships between content transformation parameters and abstractions of the content transformation parameters;
displaying the abstractions;
permitting a user to establish user-preferred media profiles in a home network using the abstractions; and
implementing the user-preferred media profiles using the content transformation parameters.

2. The method of claim 1, wherein the abstractions are human-meaningful terms.

3. The method of claim 1, comprising mapping the human-meaningful terms to respective content transformation parameters.

4. The method of claim 2, wherein at least one human-meaningful term represents a genre of video.

5. The method of claim 2, wherein at least one human-meaningful term represents a genre of audio.

6. The method of claim 1, comprising establishing at least one default media profile establishing a content transformation policy.

7. The method of claim 6, wherein a user may change from the default media profile using the abstractions, the abstractions being mapped to the content transformation parameters understandable by a computer to transform a first media content type to a second media content type.

8. An apparatus comprising:
at least one processor;
at least one computer-readable medium accessible to the processor and bearing mapping between content transformation policy and human-meaningful terms in a home network, the content transformation policy being useful by a computer to effect media transformation in the home network, the human-meaningful terms being useful for presenting a user interface to a person.

9. The apparatus of claim 8, wherein the user interface is operable to establish preferred policy in terms of the human-meaningful terms.

10. The apparatus of claim 9, wherein the human-meaningful terms include at least one of: display definition types, audio file source types.

11. The apparatus of claim 10, wherein a user may change from a default policy using the human-meaningful terms, the human-meaningful terms being mapped to content transformation parameters understandable by a computer to transform a first media content type to a second media content type.

12. A device configured to establish communication between a wide area network and a home network, the device comprising:
at least one processor, and
at least one tangible computer-readable medium accessible to the processor and bearing at least one data structure correlating terms that are meaningful to a human to respective network parameters to implement user-defined content transformation policy in the home network.

13. The device of claim 12, wherein the processor is configured to display a user interface operable to establish preferred policy in human-meaningful terms.

14. The device of claim 13, wherein the human-meaningful terms include at least display definition types.

15. The device of claim 13, wherein the human-meaningful terms include at least audio file source types.

16. The device of claim 13, wherein a user may change from a default policy using the human-meaningful terms, the human-meaningful terms being mapped to content transformation parameters understandable by a computer to transform a first media content type to a second media content type.
